(19) United States
(12) Patent Application Publication
(10) Pub. No.: US 2025/0199478 A1
(43) Pub. Date: Jun. 19, 2025

(54) SOUND PRODUCTION DEVICE FOR TIMEPIECE MOVEMENT COMPRISING A CHIMING OR ALARM MECHANISM

(71) Applicant: Ball Watch Company SA, La Chaux-de-Fonds (CH)

(72) Inventors: Huy Van TRAN, Marin-Epagnier (CH); Ludovic PEREZ, Lods (FR)

(21) Appl. No.: 18/980,945

(22) Filed: Dec. 13, 2024

(30) Foreign Application Priority Data
Dec. 15, 2023 (EP) 23217320.3

(51) Int. Cl. G04B 23/02

(52) U.S. Cl. CPC G04B 23/026

(57) ABSTRACT

A sound production device is designed to be arranged in a case of a timepiece, in association with a timepiece movement comprising a chiming or alarm mechanism, and comprises:
at least one external connecting member for assembling the sound production device to the timepiece case,
a sound producing member comprising a heel carrying at least one vibrating member made in one piece with said heel,
a damping member, assembled to the sound producing member and designed to form an assembly interface between the latter and the timepiece movement, and
one or more internal connecting members arranged solely on the damping member and designed to assemble the sound production device to the timepiece movement.

### TECHNICAL FIELD

The present invention relates to a sound production device, designed to be arranged in a case of a timepiece in association with a timepiece movement comprising a chiming or alarm mechanism, the sound production device comprising:
at least one external connecting member for assembling it to the timepiece case,
a sound producing member comprising a heel carrying at least one vibrating member made in one piece with it.

The invention also relates to a timepiece comprising a case housing such a sound production device, in which this device is associated with a timepiece movement with a chiming or alarm mechanism.

### PRIOR ART

In general terms, a known problem in the construction of timepieces with chiming or alarm mechanisms lies in the sound radiation, outside the corresponding case, of the sound produced by a sound production device arranged inside the case. Until relatively recent times, the sound production device has usually comprised, for example, at least one chiming gong connected to the plate of the corresponding timepiece movement via a heel or gong carrier. Considerable research has been undertaken with the aim of optimizing the transmission of the produced sound from the gong or gongs to the case and then through the case.

Patent application CH 700102 A2 illustrates one of the strategies followed. It describes the construction of a watch case in which one or more chiming gongs can be made directly in one piece with the middle part. Since the gongs are no longer carried by the plate of the timepiece movement, but are carried directly by the middle part itself, the transmission of the sound of the gongs to the case no longer exhibits the loss typical of conventional designs.

However, the illustrations of this patent application make it clear that the construction of such a middle part is not evident from the point of view of the machining conditions. Furthermore, such a design does not allow any obvious adjustment as regards the relative orientation between the hammers carried by the timepiece movement and the gongs, notably in view of the fact that other general constraints apply to the relative orientation between the timepiece movement and the middle part, notably the positioning of control members passing through the middle part and interacting with mechanisms of the timepiece movement.

It therefore seems preferable to provide for the design of a sound production device that is not directly made in one piece with the middle part.

Examples of the embodiment of sound production devices conforming to the aforementioned characteristics have been disclosed in the prior art.

Patent EP 2942674 B1 describes an assembly for generating a chime in association with a chiming mechanism for a watch, this assembly being made in the form of a ring made in one piece with the chiming gongs. This approach offers better access to the various parts of the assembly, thus simplifying the manufacture of the assembly as compared with the case according to the previous document. The ring is preferably force fitted into the middle part of the corresponding watch, to optimize the transmission of the sound waves produced from the gongs to the middle part. It is then possible to provide a degree of adjustment of the relative orientation between the ring and the timepiece movement, which, for its part, is positioned so as to bear against a shoulder of the middle part, in such a way that the hammers are located facing the gongs.

Although this approach requires some adaptation of the middle part as compared with a conventional design, it offers greater simplicity in the construction of the middle part and the gongs than the design described previously.

Other similar types of design have been proposed, for example the construction of a gong and its heel in one piece with the glass of a watch, made of sapphire, in patent CH 708597 A1. In this case, however, the dimensions of the gong are limited by those of the glass, the latter having a smaller diameter than the middle part.

Thus it still appears possible to propose a design which is advantageous by comparison with the known designs, in order to enable a sound production device to be constructed and mounted in a timepiece case in a simple, reliable and robust manner.

### DISCLOSURE OF THE INVENTION

A principal aim of the present invention is to propose an alternative design of a sound production device, designed to be arranged in a case of a timepiece in association with a timepiece movement comprising a chiming or alarm mechanism, the construction of the device being simple, requiring only a minimum of modifications to be made to a standard timepiece case to allow the sound production device to be assembled therein, the device allowing improved propagation of the produced sound both within and outside the associated timepiece case.

For this purpose, the present invention relates more particularly to a sound production device of the type indicated above, characterized
in that it also comprises a damping member, assembled to the sound producing member and designed to form a mechanical assembly interface between the latter and the timepiece movement, and
in that it comprises one or more internal connecting members arranged solely on the damping member and designed to assemble the sound production device to the timepiece movement.

Thanks to its specific characteristics, the sound production device according to the invention allows optimal transmission of the produced sound towards the timepiece case with which it is associated, while allowing the provision of a precise relative orientation between the sound production device and at least one hammer comprised in the associated timepiece movement. Furthermore, the fact that a mechanical connection is implemented between the sound producing member and the timepiece movement, through a damping member, advantageously allows the transmission of vibrations from or to the timepiece movement to be limited. Thus, notably in the case of a chiming mechanism with a speed regulating member using mechanical contact (for example, an inertia wheel with rollers rubbing on a cylindrical braking surface or a pallet system), the transmission of the parasitic noise of the operation of the regulating member towards the timepiece case is limited owing to the presence of the damping member.

Preferably, provision may be made to have at least one external connecting member arranged on the sound producing member to enable the latter to be assembled directly to the timepiece case.

In general terms, provision may be made for the sound producing member to be made of a material chosen from the group comprising metallic glasses and metallic materials (copper, titanium, bronze, etc.), notably steels, precious metals (silver, gold, platinum, palladium) and their alloys.

Provision may also be made for the damping member to be made of an elastomer or any suitable plastic material, notably a material chosen from the group comprising polyamides, polyoxymethylene (POM) and polyurethanes.

According to a preferred embodiment, provision may advantageously be made for the overall shapes of the sound producing member and the damping member to be such that they define between them a closed casing ring, preferably of generally annular shape.

Provision may also be made for the sound producing and damping members to be assembled to one another by at least two assembly members, arranged at a distance from one another.

According to a preferred embodiment, provision may advantageously be made for the sound producing member to comprise a strike portion located between the heel and the vibrating member, which portion is designed to be struck by a chiming or alarm hammer of the timepiece movement.

In this case, provision may preferably be made, according to a first preferred variant embodiment, for the vibrating member to be a gong extending, substantially from the strike portion, through an angle of between 180 and 720 degrees relative to a central axis of the sound production device.

Furthermore, provision may also be made for the sound producing member to comprise at least one additional gong made in one piece with the heel, and, more preferably, for the gongs to extend in two opposite directions relative to the heel. Additionally, provision may then be made for the gongs to be at least partially superimposed.

According to a second preferred variant embodiment, provision may be made for the vibrating member to be a tuning fork having two branches extending substantially from the strike portion.

In general terms, provision may be made for the vibrating member to be at least partially superimposed on the damping member in the direction of the thickness of the sound production device.

Provision may also be advantageously made for the sound production device according to the invention to have at least one oblong through opening orientated in a radial direction, to form a passage for an external control member of the associated timepiece.

The invention also relates to a timepiece comprising a case housing a timepiece movement with a chiming or alarm mechanism, wherein the timepiece movement is assembled to the case through a sound production device having some or all of the characteristics described above, the device being arranged to be able to interact with at least one chiming or alarm hammer of the timepiece movement to produce a sound.

According to a preferred variant embodiment, provision may be made for the timepiece to be made in such a way that the difference between the specific acoustic impedances of the materials used for the case, usually the middle part, and for the sound producing member is smaller than the difference between the specific acoustic impedances of the materials used for the sound producing member and for the damping member. Thanks to these additional special characteristics, transmission of the vibrations produced by the sound producing member towards the case rather than towards the timepiece movement is favoured, thus ensuring that a limited proportion of the vibrations produced is transmitted to the timepiece movement, given that a large number of them should be reflected at the interface between the two members.

### BRIEF DESCRIPTION OF THE DRAWINGS

Other characteristics and advantages of the present invention will be more clearly apparent from a perusal of the following detailed description of a preferred embodiment, which refers to the attached drawings, provided by way of non-limiting example, in which:

FIG. 1 shows a simplified front view of a timepiece, viewed from the back, comprising a sound production device according to a preferred embodiment of the invention;

FIG. 2 shows a simplified perspective view of a detail of design of the sound production device illustrated in FIG. 1;

FIGS. 3 and 4 show similar simplified perspective views of the sound production device illustrated in FIG. 1, from first and second observation points located substantially facing one another, and

FIG. 5 shows a simplified, partially transparent perspective view of a detail of design of the timepiece of FIG. 1, viewed from its dial side.

### EMBODIMENT(S) OF THE INVENTION

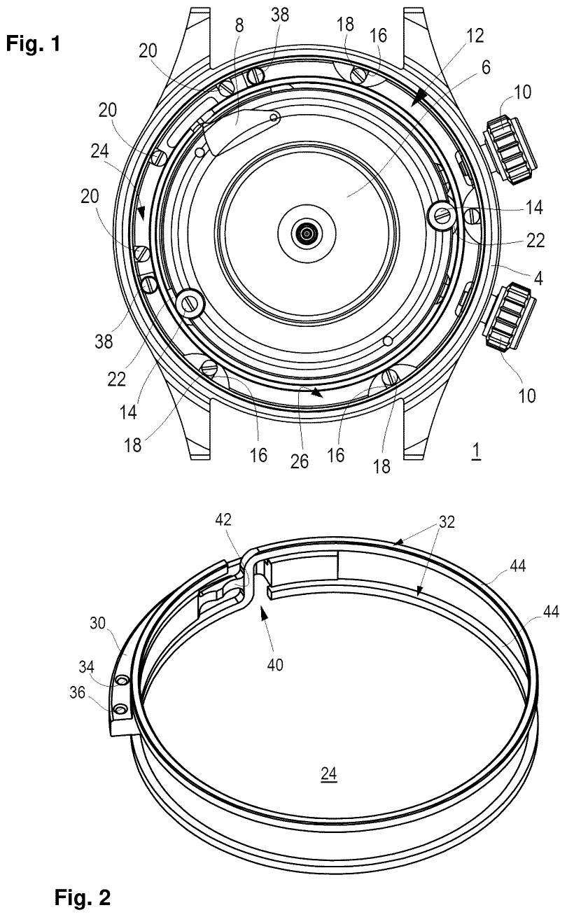

FIG. 1 shows a simplified front view of a part of a timepiece 1, viewed from the back, said timepiece comprising a sound production device according to a preferred embodiment of the invention.

The timepiece 1 comprises a case comprising a middle part 4 housing a timepiece movement 6 comprising a chiming or alarm mechanism, such a mechanism being recognizable here because of the presence of a hammer 8 designed to strike a vibrating member to produce a sound, in a conventional manner.

The timepiece 1 also comprises two external control members 10, in this case crown rods, by way of non-limiting illustration, designed to allow a user to adjust the operation of the timepiece movement 6 via the middle part 4, also in a conventional manner.

It can be seen from the overall view of FIG. 1 that the timepiece movement 6 is assembled to the middle part 4 through a casing ring 12, on a shoulder (not shown) on which it is supported, being kept in place by two screws 14, by way of non-limiting illustration.

The casing ring 12 is itself assembled to the middle part 4 by being placed to bear on a shoulder (not shown) of the latter and by being kept in place by the interaction of a plurality of metal tabs 16, screwed onto the casing ring 12 by screws 18 and engaged in one or more suitable grooves (not shown) in the middle part 4, in a conventional manner. Additionally, one or more additional screws 20, numbering three in this case by way of non-limiting illustration, are directly screwed into the middle part 4, being arranged through the casing ring 12.

Evidently, those skilled in the art will not encounter any particular difficulty in using other internal connecting members, between the casing ring 12 and the timepiece movement 6, and other external connecting members, between the casing ring 12 and the middle part 4, suited to their specific requirements, without thereby departing from the scope of the invention as defined by the attached claims. Thus, provision may, for example, be made, as an alternative, for the casing ring 12 to be pressed or force fitted into the middle part 4 as described in the prior art (in this case, at least a portion of the peripheral shell of the casing ring acts as an external connecting member).

It should be noted here that, advantageously, each of the screws 14 has an extended flat head, which could be replaced by a washer as an alternative, bearing on the casing ring 12 and being positioned in a milled recess 22 whose extension in the plane is greater than that of the head of the screw 14. Thus the relative angular orientation between the timepiece movement 6 and the casing ring 12 can be adjusted by moving the screws 14 along the milled recesses 22, when they are not fully screwed in, notably in order to allow a precise adjustment of the relative positioning between the casing ring 12 and the hammer 8 (or hammers as the case may be), as will be apparent from the remainder of the present description.

A more detailed description will now be given of the way in which the casing ring 12 according to the present invention simultaneously forms a sound production device, since it comprises a sound producing member 24 and a damping member 26, assembled to one another, in a manner which will be more clearly apparent from the illustrations in FIGS. 2 to 5.

FIG. 2 shows a simplified perspective view of the sound producing member 24 on its own.

The sound producing member 24 has a generally annular shape here, and preferably defines together with the damping member 26 a casing ring 12 of generally annular shape, so that it can be associated with a round timepiece movement, although it could evidently have a different general shape, so as to be suitable for “shaped” calibres (that is to say, those having a shape other than round, in conventional watchmaking language) without thereby departing from the scope of the invention as defined by the attached claims.

The sound producing member 24 comprises a rigid portion forming a heel 30 carrying a vibrating member 32 which here takes the form of a double gong, by way of non-limiting illustration.

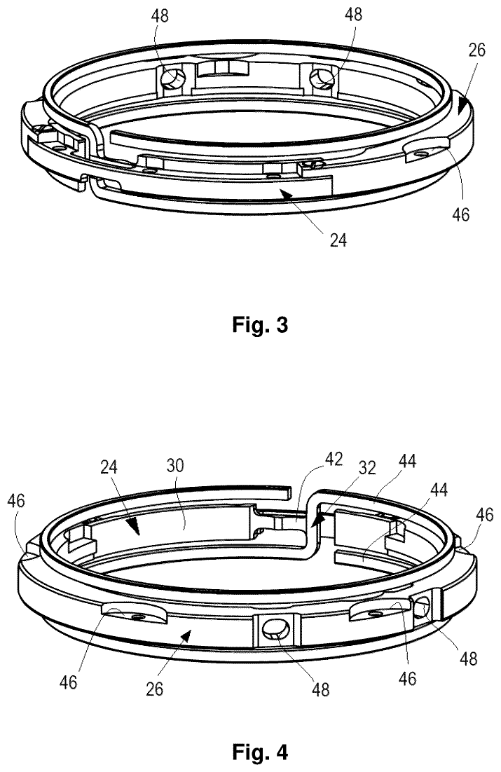

In a conventional manner, the heel 30 is designed to allow the vibrating member 32 to be mounted in the case of the timepiece 1. The heel 30 thus comprises three holes 34 (only one of which is visible in FIG. 2) through which the screws 20 for assembling to the middle part 4 are arranged, and two holes 36 (only one of which is visible in FIG. 2) for receiving assembly members 38 (in this case, screws visible only in FIGS. 1 and 3) for assembling the sound producing member 24 to the damping member 26.

Preferably, the sound producing member 24 may be made of a material chosen from the group comprising metallic glasses and metallic materials (copper, titanium, bronze, etc.), notably steels, precious metals (silver, gold, platinum, palladium) and their alloys.

Depending on the chosen material, those skilled in the art will encounter no particular difficulty in making the sound producing member 24 by using any suitable known manufacturing method, for example casting, machining or 3D printing (or “additive manufacturing technique”). It would also be feasible to use tempered steel, in which case the sound producing member may be placed in a mould for the tempering operation in order to prevent the occurrence of deformation.

A cut-out 40 is provided in the heel 30, either directly during manufacture by casting or 3D printing, or by milling or laser ablation in the context of manufacture by machining. The cut-out 40 enables a junction, having intermediate transverse dimensions, to be left free between the heel 30 and the vibrating member 32, notably in order to define a strike portion 42 designed to interact with the hammer 8 of the chiming or alarm mechanism.

The vibrating member 32 extends substantially from the strike portion 42, here taking the form of a double gong having two branches 44 extending asymmetrically relative to the junction of the vibrating member 32 with the strike portion 42. Each branch 44 comprises a first portion extending in the direction of the thickness of the timepiece movement 6, followed by an elbow providing a junction with an annular turn extending through nearly 360 degrees. The two turns are therefore partially superimposed on one another, and are also partially superimposed on the heel 30, by way of non-limiting illustration.

Evidently, those skilled in the art will be able to use any other form of vibrating member without thereby departing from the scope of the invention as defined by the attached claims, or even other forms of sound producing member. Indeed, it is possible, for example, to provide by way of an alternative a sound producing member comprising one or more gongs each having a single branch, a double gong in the form of a curved tuning fork (therefore with the two turns extending in the same direction on either side of the heel in the direction of the thickness, being superimposed on the whole length of at least one of the branches or of both branches in the case of branches of the same length), or two gongs extending on either side of the heel in its longitudinal direction. It is also possible to provide at least two gongs whose respective lengths are adjusted relative to one another so that their simultaneous actuation generates vibrations giving rise to a beat phenomenon, resulting in the emission of a sound having improved depth. Alternatively or additionally, provision may be made for at least two branches of a gong or at least two gongs to have different respective weights, possibly by being made with different respective cross sections, notably in order to generate a beat phenomenon, or in general terms. Also in general terms, provision may be made for the gong(s) to extend typically through an angle of between 180 and 720 degrees relative to the central axis of the sound production device or casing ring 12, or even for one gong or each gong to take the form of a closed ring, such rings then either being interconnected or not. In general terms, provision may also be made for the gong(s) to have any suitable type of cross section, notably round or substantially square, or even rectangular, with a constant or variable surface area, without departure from the scope of the invention as defined by the attached claims.

FIGS. 3 and 4 show similar simplified perspective views of the sound production device 12, from first and second observation points located substantially facing one another, and provide a clearer illustration of the way in which the sound producing 24 and damping 26 members are associated with one another.

The damping member 26 also has a substantially annular general shape and is assembled to the sound producing member by means of screws 38 as mentioned above.

The damping member is preferably made of an elastomer or any suitable plastic material, notably a material chosen from the group comprising polyamides, polyoxymethylene (POM) and polyurethanes.

Each of the sound producing 24 and damping 26 members preferably has an angular extension of less than 360 degrees, so that it has free ends interacting with the free ends of the other member to provide for their assembly. The members 24 and 26 may advantageously have opposing surfaces of which some are orientated in a plane substantially parallel to the general plane of the timepiece 1, to ensure satisfactory relative retention in the direction of the thickness of the timepiece 1, and others are orientated in a plane substantially perpendicular to the general plane of the timepiece 1, to ensure satisfactory relative angular positioning. Here, one of the members has cut-outs in its free ends, the shapes of which are complementary to those of the free ends of the other member. Thus the two members 24 and 26 form together a complete or closed circle. Provision may be made, alternatively, for the two members to form together an open circle, notably in the case where the sound production device or casing ring 12 is assembled to the middle part 4 by pressing or force fitting.

According to the preferred embodiment of the invention which is illustrated in the figures, by way of non-limiting illustration, the damping member 26 has a greater angular extension than the sound producing member 24.

In fact, the sound production device 12 according to the invention is intended to achieve a number of aims. It not only simplifies the mounting of a timepiece movement with a chiming or alarm mechanism in a timepiece case, but is also designed to provide optimal transmission of the sound produced by its vibrating member to the case of the timepiece, in order to ensure its satisfactory radiation towards the outside of the case.

To achieve the latter aims, it is first necessary to optimize the transmission of the sound waves from the vibrating member 32 towards the middle part 4.

For this purpose, the vibrating member 32 is made in one piece with the heel 30, the latter being assembled to the middle part 4 by placing relatively extended transmission surfaces in contact between the heel 30 and the middle part 4. The outer peripheral wall of the heel 30 may advantageously be positioned to bear against a surface of complementary shape of the middle part 4, while the placing of the three additional assembling screws 20 maintains a permanent close contact between the heel 30 and the middle part 4 in a plane substantially parallel to the general plane of the middle part 4. Additionally, provision is advantageously made for the materials used for the sound producing member 24 and for the middle part 4 to have values of specific acoustic impedance that are close to one another, to ensure good impedance matching and therefore good transmission from the sound producing member 24 towards the middle part 4.

Conversely, it is preferable to limit as far as possible the transmission of the sound waves produced by the sound producing member 24 towards the timepiece movement 6. In this respect, the damping member 26 not only acts as a damper, interposed between the middle part 4 and the timepiece movement 6, for protecting the latter in case of external impact, but also reduces the transmission of the sound waves from the sound producing member 24 towards the timepiece movement 6. This is because the sound producing member 24 is not directly connected to the timepiece movement 6 as described above, but is assembled to the latter via the damping member 26. The damping member 26 is therefore preferably made of a material having a substantially different specific acoustic impedance value from that of the sound producing member 24, in order to reduce the transmission of the sound waves at their interface. Preferably, provision may be made for the timepiece 1 to be made in such a way that the difference between the specific acoustic impedances of the materials used for the middle part 4 and for the sound producing member 24 is smaller than the difference between the specific acoustic impedances of the materials used for the sound producing member 24 and for the damping member 26. This favours the transmission of the vibrations produced by the sound producing member 24 towards the middle part 4 rather than towards the timepiece movement 6, ensuring that a limited proportion of the vibrations produced is transmitted to the timepiece movement 6, given that a large number of them should be reflected at the interface between the two members 24 and 26. Additionally, provision may be made for the constituent material of the damping member 26 to exhibit high attenuation in the transmission of the acoustic waves, in order to limit the fraction of sound waves transmitted to it that subsequently reach the timepiece movement 6, the corresponding vibrations being liable to cause problems of operation or adjustment in the timepiece movement 6 over the long term.

As indicated above, by interposing the damping member 26 between the timepiece movement 6 and the middle part 4 it is also possible to filter any parasitic noise that may be generated by the operation of the timepiece movement 6, notably by using a chiming regulation device of a mechanical type (for example, using pallets or an inertia wheel with variable inertia creating friction), while limiting the corresponding vibrations that might reach the middle part 4 and could therefore emit a parasitic sound towards the outside of the middle part 4.

It will be understood from the preceding explanations that it is preferable to provide a greater angular extension for the damping member 26 than for the sound producing member 24, since the damping member 26 provides the mechanical support for the timepiece movement 6 in the middle part 4, while it is sufficient to provide a high-quality contact between the sound producing member 24 and the middle part 4 in order to allow satisfactory radiation of the produced sounds outside the case of the timepiece 1, and that it is preferable to limit the direct contact between the sound producing member 24 and the timepiece movement 6. Evidently, those skilled in the art will be able to adapt the relative extensions of the sound producing and damping members according to their requirements, without departing from the scope of the invention as defined by the attached claims.

In general terms, provision may preferably, and advantageously, be made for the vibrating member 32 to be partially superimposed on the damping member 26, thereby limiting the overall dimensions of the sound production device 12 according to the invention.

It is also apparent from FIGS. 3 and 4 that cut-outs 46 are preferably formed in the damping member 26 to ensure the placing of the metal tabs 16 for connection to the middle part 4, to improve their mechanical stability on the damping member 26, and to allow them to be disengaged from the middle part 4 by rotation, without the need to fully remove the screws 18 retaining them on the damping member 26.

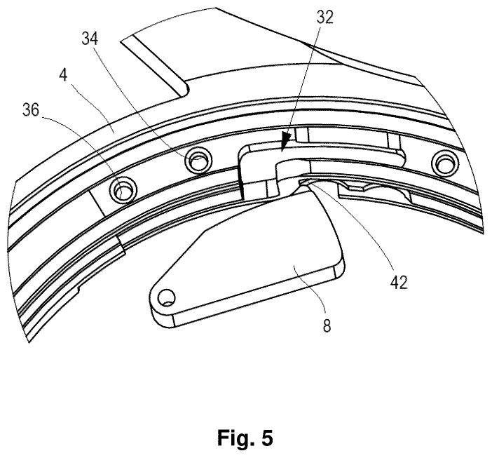

Finally, it will also be noted from FIGS. 3 and 4 that the damping member 26 has two through openings 48, preferably oblong, orientated in radial directions to define passages for the external control members 10 of the timepiece 1. Because these openings 48 are slightly oblong, it is possible to provide a greater margin of adjustment of the relative angular orientation of the timepiece movement 6 with reference to the middle part 4, notably in order to ensure the correct positioning of the hammer 8 facing the strike portion 42 of the sound producing member 24, as shown in the perspective detail view of FIG. 5.

It will also be noted that the strike portion 42 can advantageously be made so as to have a larger or smaller radius of curvature, rather than a right angle, as can be seen in FIGS. 2, 4 and 5. Such a characteristic allows for the possible implementation of fine adjustment of the angular orientation between the timepiece movement 6, and therefore the position of the hammer 8, and the sound producing member 24, over an angular range in which striking will be possible, but the distance between the hammer 8 and the strike portion 42 can be adjusted to modulate the quality of the produced sound.

From the preceding description, it is possible to understand how to construct a sound production device that has optimized acoustic properties while simultaneously performing the mechanical functions of a casing ring. Thanks to the characteristics of the invention, this sound production device is relatively simple as regards its construction and manufacture, has limited overall dimensions, and can easily be adapted to existing timepiece cases and timepiece movements without the need for any substantial modification of said cases and movements.

The implementation of the present invention is not limited to certain specifically described and/or illustrated characteristics, notably the shape of the vibrating member or the number of vibrating members used, notably whether the timepiece movement comprises a chiming or alarm mechanism, the shape of the heel, or the fact that the strike portion is placed between two rigid portions of the heel used for the purpose of its assembly onto the middle part. Indeed, provision could be made, alternatively, for the strike portion to be simply arranged in the prolongation of the heel, starting from one of its ends, even though the mechanical retention of the heel on the middle part would be slightly less satisfactory in this case.

In general terms, those skilled in the art will encounter no particular difficulty in adapting the present teachings to the implementation of a sound production device for a timepiece to meet their specific requirements while still conforming to the present invention, that is to say comprising a sound producing member connected solely to the corresponding middle part and to a damping member which, for its part, is at least connected to the timepiece movement and if necessary to the middle part as well, without departing from the scope of the invention as defined by the set of claims attached.

What is claimed is:

1. A sound production device, designed to be arranged in a case of a timepiece in association with a timepiece movement comprising a chiming or alarm mechanism, the sound production device comprising:
at least one external connecting member for assembling the sound production device to the case of the timepiece,
a sound producing member comprising a heel carrying at least one vibrating member made in one piece with said heel,
a damping member, assembled to said sound producing member and designed to form a mechanical assembly interface between said sound producing member and the timepiece movement, and
one or more internal connecting members arranged solely on said damping member and designed to assemble the sound production device to the timepiece movement.

2. The sound production device of claim 1, wherein at least one external connecting member is arranged on said sound producing member to enable said sound producing member to be assembled directly to the case of the timepiece.

3. The sound production device of claim 2, wherein said sound producing member is made of a material chosen from the group comprising metallic glasses and metallic materials including steels, precious metals and their alloys.

4. The sound production device of claim 2, wherein said damping member is made of a material chosen from the group comprising elastomers and plastic materials including polyamides, polyoxymethylene (POM) and polyurethanes.

5. The sound production device of claim 2, wherein said sound producing member and said damping member have adapted overall shapes so that they define together a closed casing ring.

6. The sound production device of claim 2, wherein said sound producing member and said damping member are assembled to one another by at least two assembly members arranged at a distance from one another.

7. The sound production device of claim 2, wherein said sound producing member comprises a strike portion located between said heel and said vibrating member, said strike portion being designed to be struck by a chiming or alarm hammer of the timepiece movement.

8. The sound production device of claim 7, wherein said vibrating member is a gong extending, substantially from said strike portion, through an angle of between 180 and 720 degrees relative to a central axis of the sound production device.

9. The sound production device of claim 8, wherein said sound producing member comprises at least one additional gong made in one piece with said heel.

10. The sound production device of claim 9, wherein said gong and said additional gong extend in two opposite directions relative to said heel.

11. The sound production device of claim 7, wherein said vibrating member is a tuning fork having two branches extending substantially from said strike portion.

12. The sound production device of claim 1, wherein said vibrating member is at least partially superimposed on said damping member in the direction of the thickness of the sound production device.

13. The sound production device of claim 2, wherein said vibrating member is at least partially superimposed on said damping member in the direction of the thickness of the sound production device.

14. The sound production device of claim 1, further having at least one oblong through opening orientated in a radial direction, to form a passage for an external control member of the timepiece.

15. The sound production device of claim 2, further having at least one oblong through opening orientated in a radial direction, to form a passage for an external control member of the timepiece.

16. A timepiece comprising a case housing a timepiece movement with a chiming or alarm mechanism, said timepiece movement being assembled to said case through a sound production device,
wherein said sound production device comprises:
at least one external connecting member for assembling said sound production device to said case of the timepiece,
a sound producing member comprising a heel carrying at least one vibrating member made in one piece with said heel,
a damping member, assembled to said sound producing member and designed to form a mechanical assembly interface between said sound producing member and said timepiece movement, and
one or more internal connecting members arranged solely on said damping member and designed to assemble said sound production device to said timepiece movement, and
wherein said sound production device is arranged to be able to interact with at least one chiming or alarm hammer of said timepiece movement to produce a sound.

17. The timepiece of claim 16, wherein at least one external connecting member is arranged on said sound producing member to enable said sound producing member to be assembled directly to said case of said timepiece.

18. The timepiece of claim 16, wherein said sound producing member and said damping member have adapted overall shapes so that they define together a closed casing ring.

19. The timepiece of claim 16, wherein said sound producing member comprises a strike portion located between said heel and said vibrating member, said strike portion being designed to be struck by a chiming or alarm hammer of the timepiece movement.

20. The timepiece of claim 16, said case comprising a middle part through which it is assembled to said sound production device, wherein the difference between the specific acoustic impedances of the materials used for said middle part and for said sound producing member is smaller than the difference between the specific acoustic impedances of the materials used for said sound producing member and for said damping member.
